(19) United States
(12) Patent Application Publication
(10) Pub. No.: US 2013/0111480 A1
(43) Pub. Date: May 2, 2013

(54) Smart Task Tracking

(71) Applicants: Susan M. Cox, Rochester, MN (US); Janani Janakiraman, Austin, TX (US); Fang Lu, Billerica, MA (US); Loulwa F. Salem, Austin, TX (US)

(72) Inventors: Susan M. Cox, Rochester, MN (US); Janani Janakiraman, Austin, TX (US); Fang Lu, Billerica, MA (US); Loulwa F. Salem, Austin, TX (US)

(73) Assignee: INTERNATIONAL BUSINESS MACHINES CORPORATION, Armonk, NY (US)

(21) Appl. No.: 13/287,190

(22) Filed: Nov. 2, 2011

(51) Int. Cl. G06F 9/46; G06F 11/30

(52) U.S. Cl. 718/100

(57) ABSTRACT

Embodiments of the invention relate to dynamic creation and tracking of one or more tasks. Each task has one or more properties that define the task. Activities are monitored in real-time, and one or more tasks associated with the monitored activity are placed in a queue. Progress of the queued tasks is monitored in view of any associated milestones. Upon completion of the task, the associated milestones are updated to reflect that either the milestones have been met or to change associated milestone data so that future processing of the monitored tasks may include the updated milestone data.

### BACKGROUND

1. Technical Field

The present invention relates to a method and system for task tracking. More specifically, the invention relates to a system and method that assesses and tracks both completed and non-completed tasks.

2. Description of the Prior Art

Multi-tasking is the process in which two or more tasks are performed at one time. This process may take place in a parallel computing application, or it may be a process that takes place by a person with respect to management of tasks in a commercial environment, a non-commercial environment, or a combination of these environments.

When managing multiple tasks, it is common for one task to be processed while another tasks remains in a queue. At the same time, the tasks may be related such that one task may need to be processed with respect to the second task. A delay in processing a first task may affect a delay in processing of the second task, or in one embodiment processing the second task altogether. It is known that a task in a queue may be neglected for various reasons, whether intentional or unintentional. For example, sometimes people get distracted when completing the first task and forget about the second or any subsequent tasks. Accordingly, in a multi-tasking environment there is a need for management and oversight of the tasks so that none of the tasks suffer from neglect or distraction.

### SUMMARY OF THE INVENTION

This invention comprises a method, system, and apparatus for dynamic task management.

In one aspect, a computer implemented method is provided for dynamic task management. Two or more tasks are stored in data storage. Each of these tasks includes at least one milestone pertaining to duration for completion of the stored task. Activities associated with the stored tasks are monitored in a concurrent manner. A tracking queue, hereinafter also referred to as a queue, is provided and each task associated with one of the monitored activities is placed in the queue. When a defined milestone is completed, the completion is recognized, and the defined milestone data is updated in the data storage. The duration for completion of one or more of the tasks is dynamically adjusted based upon changed in a behavior pattern, which is reflected in any updates to the milestone data.

In another aspect, a system is provided with a processing unit in communication with storage media. A functional unit is provided in communication with the processing unit, with the functional unit to support dynamic task management. The functional unit is provided with an activity manager, a progress manager, an update manager, and an adjustment manager. The activity manager functions to monitor two or more activities associated with at least one task. More specifically, the activity manager places each of the tasks in a tracking queue. The progress manager, which is in communication with the activity manager, functions to track the tasks in the tracking queue. More specifically, the progress manager tracks a time interval employed to attain a milestone associated with completion of the task being tracked. The update manager, which is in communication with the progress manager, functions to update the milestone responsive to completion of the milestone. The adjustment manager, which is in communication with the update manager, functions to dynamically adjust duration for completion of the tasks based on changes in a behavior pattern. In one embodiment, the behavior pattern is reflected in the milestone data and updated by the update manager.

In yet another aspect, a computer program product is provided for tracking multiple tasks, each of the tasks having disparate completion times associated therewith. The computer program product includes a computer-readable storage medium having computer readable program code embodied thereon, which when executed causes a computer to implement a method pertaining to dynamic task management. More specifically, the computer program product stores two or more tasks in storage media. Each of the stored tasks includes one or more defined milestones, with each milestone associated with a duration for completion of the stored tasks. The computer program product concurrently monitors two or more activities that are associated with one or more of the stored tasks. Each of the tasks associated with the monitored activities is placed in a tracking queue. The computer program product tracks progress of the tasks in the tracking queue that are being monitored. More specifically, the tracking pertains to time for reaching the defined milestone data associated with task completion. The computer program product recognizes completion of the milestone and updates the associated milestone data in the storage media. In addition, the computer program product dynamically adjusts the duration for completion of the tasks based upon changes in behavior patterns as reflected in the updated milestone data.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flowchart illustrating a process for managing multiple activities.

FIG. 2 is a flow chart illustrating a process for entering tasks to be monitored.

FIG. 3 is a block diagram illustrating tools embedded in a computer system to provide task management and tracking of the tasks in a smart and effective manner.

FIG. 4 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as tools, modules, and/or managers. The functional units may be implemented in programmable hardware devices such as field programmable gate arrays, programmable array logic, programmable logic devices, or the like. The functional units may also be implemented in software for execution by various types of processors. An identified functional unit of executable code may, for instance, comprise one or more physical or logical blocks of computer instructions which may, for instance, be organized as an object, procedure, function, or other construct. Nevertheless, the executables of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

Electronic tools are becoming abundantly popular for managing aspects of organization, including task management. Whether with respect to non-commercial tasks, education, or commercial tasks, we are all faced with execution of tasks. These tasks can be simple or complex. One popular tool for task management is an electronic calendar, where data is input pertaining to start and end times for task completion, and in one embodiment a reminder when a completion time is approaching for a non-completed task. However, the electronic calendar is a static tool for task management. Each task must be entered and when completed, the task completion also must be entered. The use of a calendar requires a manual intervention of some form. Accordingly, there is a need for a tool to dynamically monitor and manage all aspects of task completion, thereby mitigating or eliminating manual intervention.

A tool is employed to sense activity and identify one or more tasks associated with the activity. More specifically, the tool is configured to monitor multiple activities, with each activity including one or more tasks and associated reminder mechanisms. In one embodiment, the tool is in communication with a user, and specifically, a body of the user. For example, the tool may be in the form of a camera or a sensor, or a combination thereof, to monitor activity. The direct communication of the tool with the user supports the tool sensing the location and activity of the user.

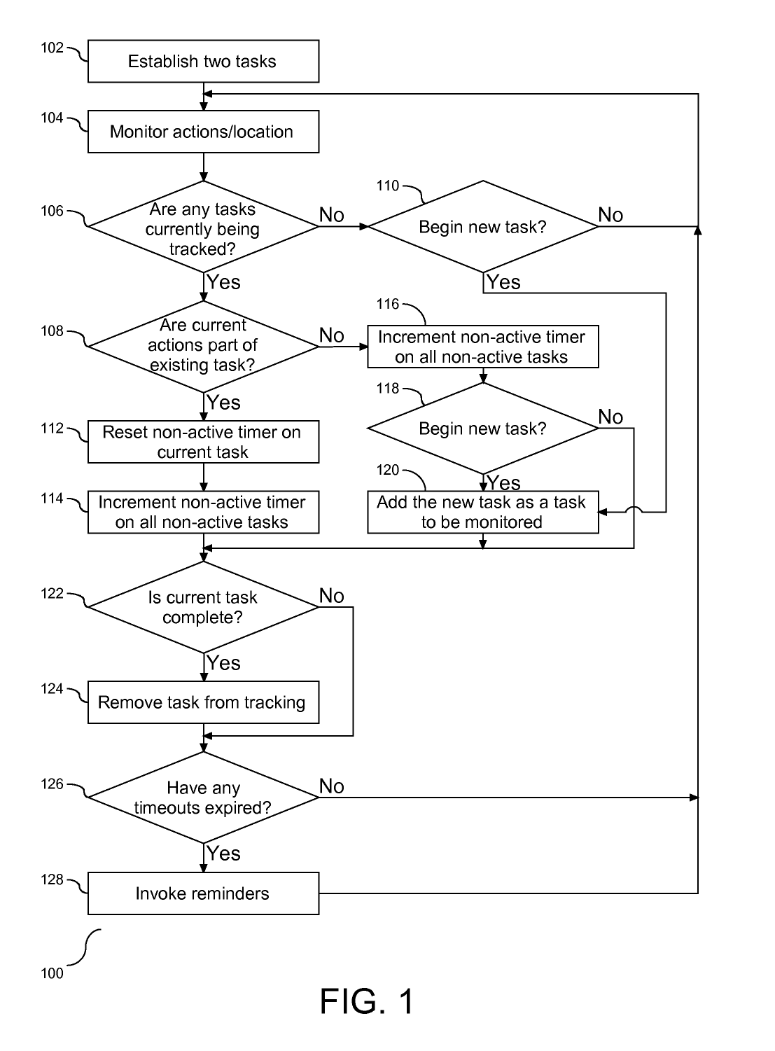

FIG. 1 is a flow chart (100) illustrating a process for the tool to manage multiple activities. Initially, a user establishes two main tasks to be monitored, task₁ and task₂ (102). Following step (102), both the actions and the location of the user are monitored (104). It is then determined if any tasks are in the process of being tracked (106). A positive response to the determination at step (106), is followed by determining if the current actions that are being monitored are a part of one of the established tasks, task₁ and task₂ (108). Conversely, a negative response to the determination at step (106) is followed by ascertaining if the user is set to begin a new task (110). A negative response to the determination at step (110) is following by a return to step (104). Accordingly, established tasks are monitored based on the activity of the user.

As tasks are monitored, the activity of a user is observed in view of the established tasks. A positive response to the determination at step (108) is followed by resetting a non-active timer on a current task (112). The basis for the reset at step (112) is that the user has been determined to be participating in a task designated to be monitored. In addition, the non-active timer on all non-active tasks is incremented as the non-active tasks are not currently in an active state (114). Similarly, a negative response to the determined at step (108) is also followed by resetting the non-active timer on all non-active tasks (116). In one embodiment, the non-active time may be set for a defined period of time, such as the time to complete an action associated with the active task being monitored. Accordingly, the negative response to the determination at step (108) demonstrates that the user is participating in a task, but the task is not designated to be monitored.

Following step (116), it is determined if the sensed activity of the user should be designated as a new task to be monitored (118). A positive response to the determination at step (118) and a positive response to the determination at step (110) are both followed by adding the new task, task₃, as a task to be monitored (120). In one embodiment, the aspect of adding a new task to be monitored includes adding the new task as a subtask of an existing task and defining a time interval for completion of the new task, also referred to as a timeout mechanism. Accordingly, the aspect of monitoring existing tasks supports dynamically creating new tasks and subtasks, each with their own characteristics to be monitored in conjunction with defined tasks and subtasks.

Following the addition of one or more tasks or sub-tasks at step (120), a negative response to the determination at step (118), or completion of step (114), it is determined if the current task being tracked is complete (122). Once a task has been completed, the aspect of tracking the task is moot. As such, a positive response to the determination at step (122) is followed by removal of the task from current tracking (124). However, a negative response to the determination at step (122) is followed by determining if any established timeout mechanisms for the current non-completed tasks has expired (126).

As explained at step (120), each defined tasks may be configured with a defined time interval for completion, with different tasks having the same or different defined timeout mechanisms. A positive response to the determination at step (126) is followed by invoking a reminder mechanism (128). More specifically, if one or more of the tasks was set to be completed after a set time interval and the task was not completed within the defined interval, then a reminder mechanism is invoked to inform the user that the current task has not been completed and the time set to complete the task(s) has expired. In one embodiment, the manner of sending the reminder may be customized. Similarly, in one embodiment, the user may modify the characteristics of the task, including duration for completion and the time interval for communicating a reminder. Following a negative response to the determination at step (126) or completion of step (128), the task monitoring process returns to step (104).

The process of monitoring activities defined as tasks, and associated reminders, enables the user to multi-task in an intelligent manner. At step (118), a new activity may be detected, with the new activity being new to the monitoring process. More specifically and as demonstrated at steps (108) and (118), as a defined task is being monitored, an action of the user can be recognized and added to the list of defined tasks. As described above, a sensor and/or camera may be employed to monitor activity in real-time. Accordingly, the process supports monitoring multiple defined tasks and dynamically adding and defining new tasks to be joined with the previously defined tasks for monitoring.

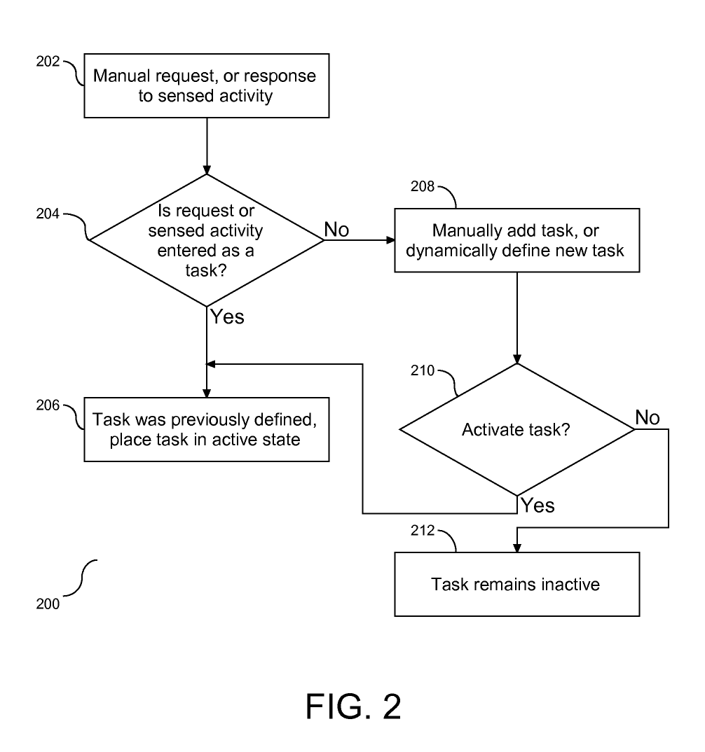

Tasks may be added to the monitoring system at any time. Specifically, tasks may be manually added to the monitoring system, or tasks may be recognized through activity of the user and added in response to the activity. FIG. 2 is a flow chart (200) illustrating a process for entering a task to be monitored. In one embodiment, each entered task is organized and stored in a data structure. In response to a manual request or in response to a sensed activity (202), it is determined if the sensed activity is entered as a task in the data structure (204). In one embodiment, each task defined in the data structure includes defining characteristics. The determination at step (204) assesses whether the characteristics of the sensed or requested activity matches any of the characteristics of a previously entered task. In one embodiment, the presence of a match may be an indicator of an entered task that is in an inactive state. A positive response to the determination at step (204) is an indication that the task was previously defined, and it is placed in an active state (206). Conversely, a negative response to the determination at step (204) is followed by either manually adding the task to the data structure or parsing the characteristics of the activity and dynamically creating and defining a new task in the data structure (208). Accordingly, activity is monitored to dynamically add one or more new tasks to the data structure, wherein the new tasks may be assigned pre-defined task information or the new tasks may be dynamically configured with new tasks information.

The process of monitoring and adding a new task to the data structure ascertains whether the new task may fit within the structure of a previously entered and defined task. More specifically, when adding a new task to the data structure, it is determined if the new task matches in its entirety or closely with an existing and defined task. One of the characteristics of a defined task includes a time duration for completion of a tasks based upon historical data of a behavior pattern. As the tasks are completed, the duration for completion may be entered into the data structure. This duration information may then be employed when a new task is dynamically configured so that the duration for completion is projected based upon recent data.

As described above, both active tasks and current activity are monitored. The process of monitoring a task is to ensure completion thereof. The process of monitoring activity is to determine if the activity falls within the definition of a current task being monitored or if the activity should be defined as a new task and added to the queue for monitoring and completion. The monitoring process recognizes an action that makes up one or more tasks. As shown above, a non-defined task may be defined and entered into a data structure. Once the task is defined, it is determined if the recently defined task should be placed in an active state for monitoring (210). A positive response to the determination at step (210) is followed by a return to step (206) where a defined task is placed in an active state for monitoring. However, a negative response to the determination at step (210) is an indication that the recently defined task should remain in an inactive state to be activated at a later time (212). Accordingly, activity is monitored together with the aspect of correlating the activity to a task.

As illustrated above, activity by its very nature is dynamic and subject to change. At the same time, one or more tasks associated with activity are managed in order to maintain the activity. New tasks may be dynamically added to the activity based upon data that is gathered from a camera and/or sensor in real-time. Furthermore, a reminder system may be invoked to communicate the tasks and timeliness associated therewith. The reminder system may be based upon configurations associated with each defined task, or based on past actions with the same or similar category of tasks. Accordingly, as shown in FIGS. 1 and 2, a method for effectively utilizing a smart appliance is provided to monitor current and future activities in communication with the camera and/or sensor.

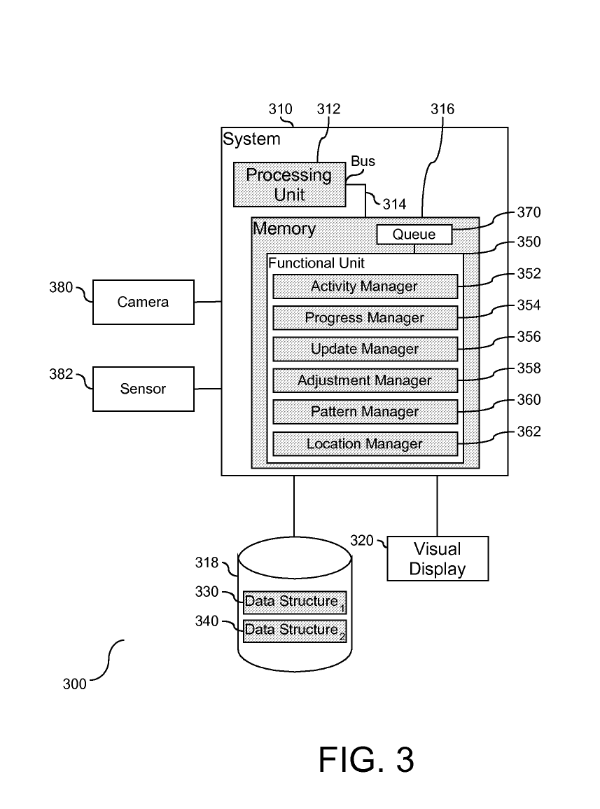

FIGS. 1 and 2 illustrated above demonstrate the different processes to dynamically support task management. Task management and maintenance of an associated schedule may be supported by hardware and/or software tools. FIG. 3 is a block diagram (300) illustrating tools embedded in a computer system to provide task management and tracking of activity. As shown, a computer system (310) is provided with a processing unit (312) in communication with memory (316) across a bus (314) in communication with data storage (318) and a visual display (320).

As described above, at least one data structure (330) is maintained to store data associated with one or more tasks, the data including properties of the task, such as duration for completion, milestones, reminder details, etc. In one embodiment, a second data structure (340) is provided to store data associated with one or more sub-tasks, for each task in the first data structure (330) that includes one or more subtasks. In one embodiment, a subtask and a task have a hierarchical relationship wherein the task relies on completion of the subtask for one or more properties associated with the task. Similar to the tasks, the second data structure (340) includes properties associated with each task, including but not limited to, an identifier for the related task, duration for completion, milestones, reminder details, etc. In one embodiment, the first and second data structures (330) and (340) may be in the form of databases. The first and second data structures (330) and (340), respectively, are stored in data storage (318) in communication with the system (310), although in one embodiment, the data structures (330) and (340) may be stored in data storage remote from the system (310).

The system (310) is provided with a functional unit (350) in communication with data structures (330) and (340). More specifically, the functional unit (350) includes tools to support smart task tracking, including an activity manager (352), a progress manager (354), an update manager (356), an adjustment manager (358), a pattern manager (360), and a location manager (362). The activity manager (352) is responsible for monitoring two or more activities that are associated with at least one task. Based upon the monitoring and data gathered from the activity manager (352), each of the tasks associated with the activity is placed in a tracking queue (370), hereinafter referred to as a queue. As shown, the queue (370) is a tool within memory (316) and in communication with the functional unit (350). In one embodiment, the queue (370) may be embedded within the functional unit (350). The queue (370) functions to monitor progress of active tasks.

The progress manager (354) is shown in communication with the activity manager (352). The progress manager (354) functions to track the progress of tasks in the queue (370). As described above, tasks that are employed to monitor activity are placed in a queue and processed based upon their placement in the queue (370). The goal is for a task to be completed, and upon completion to exit the queue (370). As described above, each task may have one or more related subtasks. In one embodiment, progress of an active subtask is monitored in the queue (370). Each task or subtask has properties that define the task or subtask, such properties including but not limited to milestone data. As the task or subtask is being processed, it may attain one or more milestones which indicate the efficiency associated with processing of the task or subtask. Accordingly, by tracking tasks or subtasks in the queue (370), the progress manager (354) tracks the time to attain a milestone associated with completion of the task and/or subtask.

Milestones are either met or not met. Once a milestone is attained, the associated data is updated. In one embodiment, the update is used as an element within the historical data tracking so that a future task may have a reduced or increased time to attain the milestone. The update manager (356), which is in communication with the progress manager (354) functions to update the milestone with respect to completion thereof. As explained herein, a task is employed to define an activity, and a milestone is employed to manage the tasks for timely completion. The task has properties associated therewith that define the task and the duration for completion. The adjustment manager (358), which is in communication with the update manager (356), is employed to make adjustments to properties of the task based upon current data. More specifically, the adjustment manager (358) dynamically adjusts the duration for completion of one or more tasks based upon any changes in behavior patterns that are ascertained and reflected in the milestone data gathered by the update manager (356). In one embodiment, the adjustment manager (358) reflects adjusted data in the data structure that organizes and stores the properties associated with the task. Accordingly, tasks are dynamically tracked and managed both for current assessment as well as adjustment for future activities.

Tasks are dynamically managed, and at the same time, activities are dynamically monitored so that new tasks may be added to the queue (370). The new tasks may be tasks that are present in the data structure, so that adding them to the queue supports employing an already defined task. Alternatively, new tasks may be created and added to the data structure (330) and at the same time added to the queue (370). To support dynamic monitoring of activity, a pattern manager (360) is provided in communication with the activity manager (352). More specifically, the pattern manager (360) functions to recognize a behavior pattern of one or more defined tasks. Based upon a sensed recognition of a defined task, the pattern manager (360) dynamically adds the defined task associated with the recognized pattern to the queue (370). At the same time, the pattern manager (360) assigns pre-defined information to the task added to the queue (370). Since some sensed activities may not be associated with a defined task, the activity manager (352) may dynamically add a new task to the queue (370), which includes dynamically configuring the new task information for the added task and also storing the new task information in the data structure (330).

In one embodiment, a camera (380) and a sensor (382) are provided in communication with the system (310), and are employed together or separately to attain location information. The activity manager (352) employs the location information gathered by the camera (380) and/or sensor (382) to associate a location with the task being managed. At the same time, the activity manager (352) tracks a user with the associated location. In addition, the location manager (362) is provided in communication with the activity manager (352). The location manager (362) functions to detect the location of the user in real-time, and also sends a task notification to the user in response to the detected location. In one embodiment, the location manager (362) sends an inquiry to the user to track a task associated with the task notification. In one embodiment, the inquiry is in the form of an electronic communication (not shown). Accordingly, the location manager employs the tools of the camera (380) and/or sensor (382) to gather location identification data and to communicate task data with a user in real-time.

As shown herein, the managers (352)-(362) of the functional unit (350) are provided local to the system (310), and more specifically, residing in memory (316) of the system (310). In one embodiment, the managers may reside as hardware tools external to memory (316), or they may be implemented as a combination of hardware and software. Similarly, in one embodiment, the managers may be combined into a single functional item that incorporates the functionality of the separate items. As shown herein, each of the manager(s) is shown local to one data site. However, in one embodiment they may be collectively or individually distributed across a shared pool of configurable computer resources and function as a unit to manage one or more tasks and task related activity in real-time. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

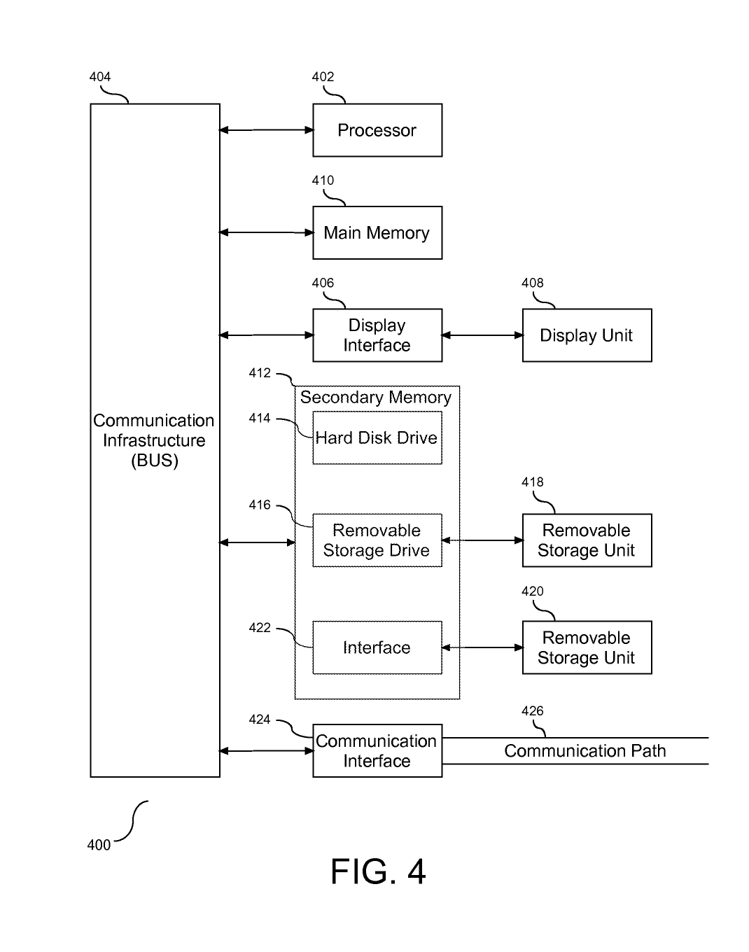

Referring now to the block diagram of FIG. 4, additional details are now described with respect to implementing an embodiment of the present invention. The computer system includes one or more processors, such as a processor (402). The processor (402) is connected to a communication infrastructure (404) (e.g., a communications bus, cross-over bar, or network).

The computer system can include a display interface (406) that forwards graphics, text, and other data from the communication infrastructure (404) (or from a frame buffer not shown) for display on a display unit (408). The computer system also includes a main memory (410), preferably random access memory (RAM), and may also include a secondary memory (412). The secondary memory (412) may include, for example, a hard disk drive (414) and/or a removable storage drive (416), representing, for example, a floppy disk drive, a magnetic tape drive, or an optical disk drive. The removable storage drive (416) reads from and/or writes to a removable storage unit (418) in a manner well known to those having ordinary skill in the art. Removable storage unit (418) represents, for example, a floppy disk, a compact disc, a magnetic tape, or an optical disk, etc., which is read by and written to by removable storage drive (416). As will be appreciated, the removable storage unit (418) includes a computer readable medium having stored therein computer software and/or data.

In alternative embodiments, the secondary memory (412) may include other similar means for allowing computer programs or other instructions to be loaded into the computer system. Such means may include, for example, a removable storage unit (420) and an interface (422). Examples of such means may include a program package and package interface (such as that found in video game devices), a removable memory chip (such as an EPROM, or PROM) and associated socket, and other removable storage units (420) and interfaces (422) which allow software and data to be transferred from the removable storage unit (420) to the computer system.

The computer system may also include a communications interface (424). Communications interface (424) allows software and data to be transferred between the computer system and external devices. Examples of communications interface (424) may include a modem, a network interface (such as an Ethernet card), a communications port, or a PCMCIA slot and card, etc. Software and data transferred via communications interface (424) are in the form of signals which may be, for example, electronic, electromagnetic, optical, or other signals capable of being received by communications interface (424). These signals are provided to communications interface (424) via a communications path (i.e., channel) (426). This communications path (426) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (410) and secondary memory (412), removable storage drive (416), and a hard disk installed in hard disk drive (414).

Computer programs (also called computer control logic) are stored in main memory (410) and/or secondary memory (412). Computer programs may also be received via a communication interface (424). Such computer programs, when run, enable the computer system to perform the features of the present invention as discussed herein. In particular, the computer programs, when run, enable the processor (402) to perform the features of the computer system. Accordingly, such computer programs represent controllers of the computer system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
storing at least two tasks in data storage, each of the at least two tasks includes at least one defined milestone associated with duration for completion of the stored task;
concurrently monitoring at least two activities associated with one or more of the stored tasks, including placing each task associated within one of the monitored activities in a tracking queue;
tracking progress of the monitored tasks in the tracking queue, including time for attainment of the defined milestone data associated with task completion in the data storage;
recognizing completion of the defined milestone and updating the defined milestone data in the data storage; and
dynamically adjusting duration for completion of at least one of the tasks based on changes in a behavior pattern as reflected in the updated milestone data.

2. The method of claim 1, further comprising recognizing a behavior pattern that comprises at least one of the defined tasks, and dynamically adding the at least one defined task associated with the recognized pattern to the tracking queue in response to the recognition.

3. The method of claim 2, wherein the step of dynamically adding the at least one defined task to the tracking queue further comprising assigning pre-defined task information to the added task.

4. The method of claim 1, further comprising dynamically adding a new task to the tracking queue, including dynamically configuring new task information for the new added task and storing the new task information in the data storage.

5. The method of claim 1, further comprising associating a location with the task, and tracking a user with the associated location.

6. The method of claim 5, further comprising in real-time detecting the location of the user and sending a task notification to the user in response to the detected location, including inquiring with the user for tracking a task associated with the task notification.

7. A system comprising a processing unit in communication with data storage;
a functional unit in communication with the processing unit, the functional unit comprising:
an activity manager to monitor at least two activities associated with one or more tasks, the activity manager to place each of the tasks in a tracking queue;
a progress manager in communication with the activity manager, the progress manager to track the tasks in the tracking queue, including time to attain a milestone associated with task completion;
an update manager in communication with the progress manager, the update manager to update the milestone in response to completion of the milestone; and
an adjustment manager in communication with the update manager, the adjustment manager to dynamically adjust duration for completion of at least one of the tasks based on changes in a behavior patterns as reflected in the milestone data as updated by the update manager.

8. The system of claim 7, further comprising a pattern manager in communication with activity manager, the pattern manager to recognize a behavior pattern that comprises at least one of the defined tasks, and to dynamically add the at least one defined task associated with the recognized pattern to the tracking queue in response to the recognition.

9. The system of claim 8, wherein the pattern manager assigns pre-defined task information to the added task.

10. The system of claim 7, further comprising the activity manager to dynamically add a new task to the tracking queue, including dynamically configuring new task information for the new added task and storing the new task information in the data storage.

11. The system of claim 7, further comprising the activity manager to associate a location with the task, and to track a user with the associated location.

12. The system of claim 11, further comprising a location manager in communication with the activity manager, the location manager to detect the location of the user in real-time and to send a task notification to the user in response to the detected location, including inquiring with the user for tracking a task associated with the task notification.

13. A computer program product for use with tracking tasks with disparate completion time, the computer program product comprising a computer readable storage medium having computer readable program code embodied thereon, which when executed causes a computer to implement the method comprising:
storing at least two tasks in data storage, each of the at least two tasks includes at least one defined milestone associated with duration for completion of the stored task;
concurrently monitoring at least two activities associated with one or more of the stored tasks, including placing each task associated within one of the monitored activities in a tracking queue;
tracking progress of the monitored tasks in the tracking queue, including time for attainment of the defined milestone data associated with task completion in the data storage;
recognizing completion of the defined milestone and updating the defined milestone data in the data storage; and
dynamically adjusting duration for completion of at least one of the tasks based on changes in a behavior pattern as reflected in the updated milestone data.

14. The computer program product of claim 13, further comprising recognizing a behavior pattern that comprises at least one of the defined tasks, and dynamically adding the at least one defined task associated with the recognized pattern to the tracking queue in response to the recognition.

15. The computer program product of claim 14, wherein the instructions for dynamically adding the at least one defined task to the tracking queue further comprising assigning pre-defined task information to the added task.

16. The computer program product of claim 13, further comprising dynamically adding a new task to the tracking queue, including dynamically configuring new task information for the new added task and storing the new task information in the data storage.

17. The computer program product of claim 13, further comprising associating a location with the task, and tracking a user with the associated location.

18. The computer program product of claim 17, further comprising in real-time detecting the location of the user and sending a task notification to the user in response to the detected location, including inquiring with the user for tracking a task associated with the task notification.
